(19) United States
(12) Patent Application Publication
(10) Pub. No.: US 2010/0043703 A1
(43) Pub. Date: Feb. 25, 2010

(54) Electrical separation unit for a liquid supply pipe

(76) Inventor: Jan Reichler, (US)

Correspondence Address: Joseph M. Kinsella Jr.;Factor & Lake, 1327 W. Washington Blvd., Suite 5G/H, Chicago, IL, 60607, US

(21) Appl. No.: 11/791,392

(22) PCT Filed: Oct. 5, 2005
(86) PCT No.: PCT/EP05/10698

§ 371 Date: Oct. 14, 2009

(30) Foreign Application Priority Data
Nov. 24, 2004 (DE) 10 2004 056 789.1

(51) Int. Cl. B05B 5/16

(52) U.S. Cl. 118/621; 204/660; 204/661

(57) ABSTRACT

The invention concerns an electric separation unit (28) for a liquid supply pipe (12), in particular for a supply pipe used for paint. Said unit comprises a housing (30) having a chamber (34), wherein a discharge sheath (44) is arranged. The latter forms part of a fluid channel, which extends from the inlet (52) to the outlet (54) of the housing (30). The liquid contained in the sheath can be discharged by pressurizing the outer part of the discharge sheath (44) and compressing said sheath, an isolating passageway not containing any liquid passage being thus obtained.

The invention relates to an electrical separation unit for a liquid supply pipe.

The problem of electrically insulating a spraygun, connected to a high-voltage, of an electrostatic painting plant from the rest of the plant components has already been addressed in DE 102 33 006 A1. This document, in connection with a piggable moving supply system, proposes moving pigs by means of compressed air in each case such that a pipe section of predefined length of the supply pipes produced from electrically insulating plastics material is in each case filled with air, in other words is free from paint.

To ensure that the respectively desired electrical insulation between high-voltage component and component connected to frame potential is guaranteed, the position of different pigs must be monitored using detectors, wherein a distinction must always be made between pigs which delimit the leading end of a paint packet and pigs which delimit the trailing end of a pig packet.

Similar problems occur when conveying conductive solvents in pipes of electrostatic paint plants and also in connection with other loads that are to be connected to a high-voltage, for example electrostatic spray bells or electrodes.

The problem of reciprocal electrical separation of sections of a supply pipe also occurs not only with liquid media but also with gaseous and free-flowing powdered media. In the present description and claims these media are all incorporated by the term liquids.

The present invention is intended to disclose an electrical separation unit for a liquid supply pipe in which it may be more easily ensured, and also without the use of position sensors that cooperate with pigs, that the separation unit brings about the desired electrical separation.

This object is achieved according to the invention by a separation unit with the features disclosed in claim 1.

In the separation unit according to the invention a liquid channel is formed in a housing and may optionally be cleared for conveying liquids or may be closed by a displacement body. The dimensions and therefore the quality of the electrical insulating path may be reliably stipulated by way of the dimensions of the displacement body. That the displacement body is in the correct position in each case is ensured by the mechanically simple construction of the separation unit.

Advantageous developments of the invention are recited in the subclaims.

The development of the invention according to claim 2 is advantageous because the movement of the displacement body between the conveying position and the separating position is obtained without relative movement by sliding. The separation unit is therefore distinguished in that it operates reliably and substantially free from friction even where manufacturing tolerances and impurities exist.

With the rotationally symmetrical construction of the displacement body according to claim 3 it is possible for the liquid channel of the housing to be completely closed. The liquid channel also has a flow-promoting shape and may be cleaned particularly easily. The same applies to the displacement body.

The development of the invention according to claim 4 is advantageous in view of secure and tight assembly of the displacement body on the housing.

The development of the invention according to claim 5 ensures that the pressurisable displacement body predefines a precise wall area of the liquid channel even in the depressurised state. This is particularly advantageous if the separation unit is part of a piggable conveying system since the pigs then also clean the inner face of the displacement body.

With the development of the invention according to claim 6 a smoothly continuous through-channel of the separation unit is obtained, and this is advantageous with respect to piggability and cleaning.

The development of the invention according to claim 7 is advantageous with respect to optimum freedom from jolts in the connection regions of the separation unit.

With the development of the invention according to claim 8 the displacement body is flattened in a predefined manner when pressurised.

With the development of the invention according to claim 9 the displacement body successively displaces the liquid in the liquid channel to one of the connection openings of the housing. Liquid inclusions between the layers of the compressed, flat displacement body are thereby avoided.

A simple and secure separation point may also be attained with the development of the invention according to claim 10 without sliding of the components. Wall sections of the displacement body are in the process displaced with only slight resilient widening between blocking position and conveying position.

The development of the invention according to claim 11 also achieves a defined liquid-free path in the conveying connection in the interior of the housing of the separation unit by using mechanical means which are easy to operate and simple to monitor.

The development of the invention according to claim 12 is advantageous with respect to favourable flow conditions.

The development of the invention according to claim 13 has the advantage that the transition between conveying position and blocking position of the separation unit may be brought about without liquid having to be released into the pipe containing the separation unit for this purpose. The volume of liquid in the separation unit is displaced in the direction that is transverse to the conveying direction, so the volume of liquid in the pipe is unchanged.

According to claim 14 it may very easily be checked whether the actual insulation, which the separation unit actually achieves, matches the desired requirements.

According to claim 16 it may easily and compulsorily be ensured that application of high voltage to a load connected to the supply pipe can only take place if the separation unit brings about the requisite electrical insulation.

The development of the invention according to claim 17 allows a liquid load connected to the supply pipe to also supply liquid at times when the separation unit has to adopt its separating position, so the load, for example an electrostatic spraygun, can be connected to high voltage.

The invention will be described in more detail hereinafter with reference to embodiments and with reference to the accompanying drawings, in which:

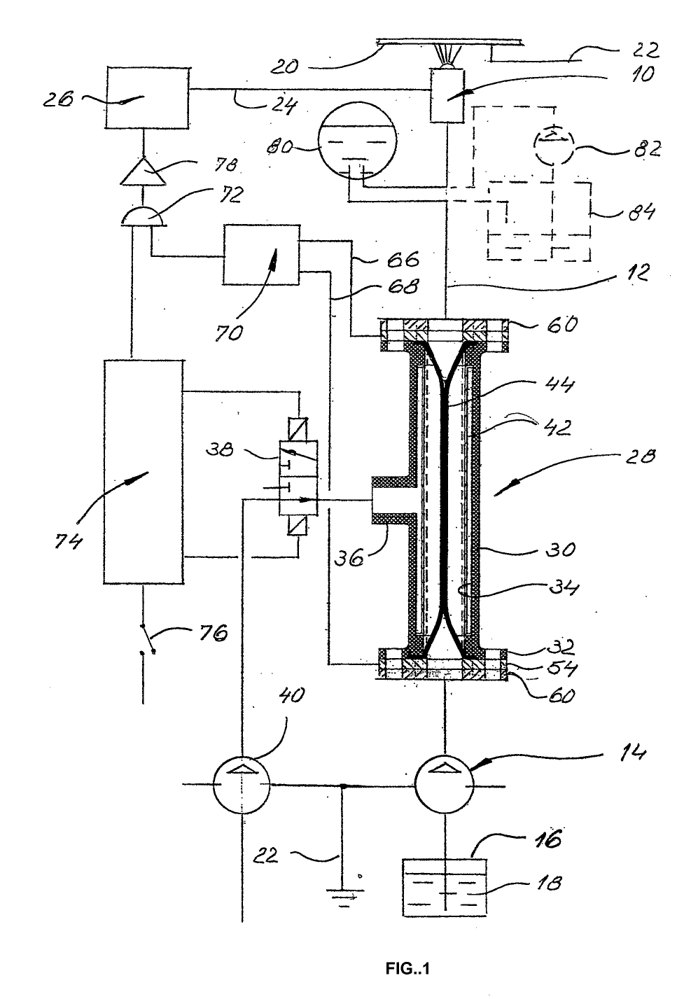

FIG. 1 shows a schematic illustration of a workstation for electrostatic spray-painting using a voltage separation unit arranged in a paint supply pipe which is reproduced in an axial section,

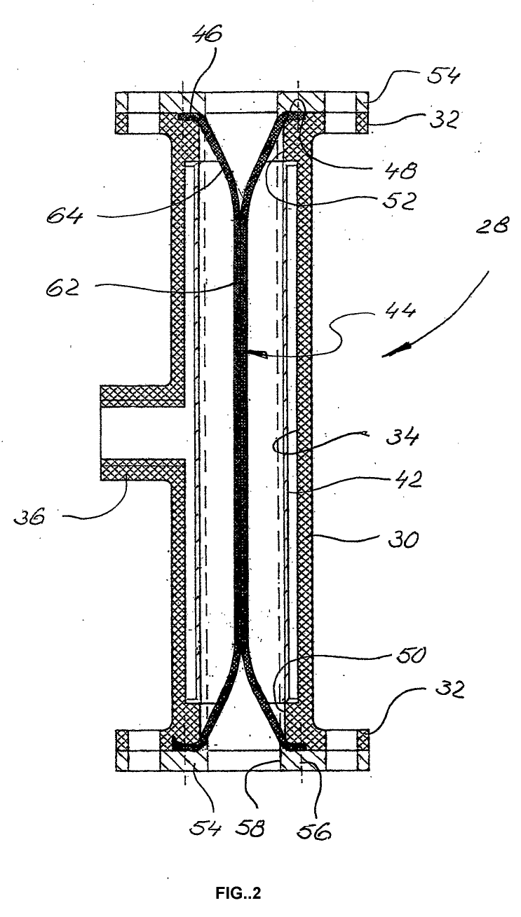

FIG. 2 shows an axial section through the separation unit according to FIG. 1 on an enlarged scale,

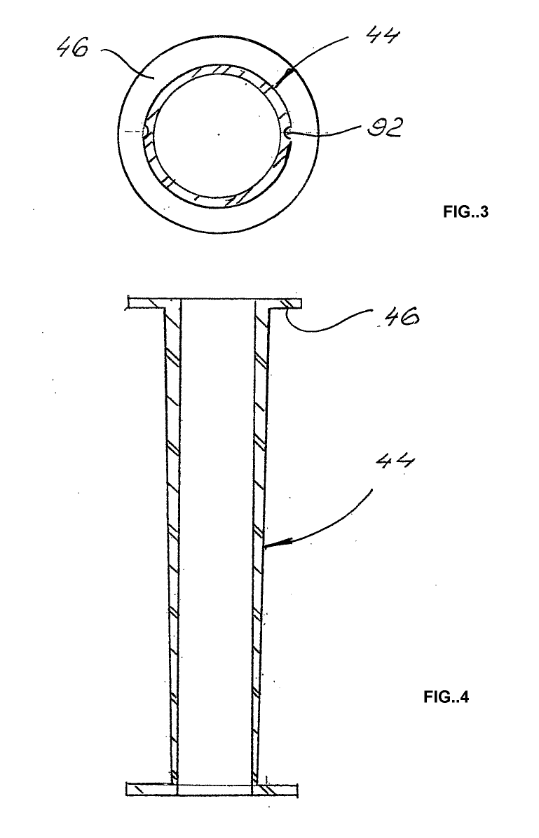

FIG. 3 shows a transverse section through a modified displacement sheath for a separation unit according to FIGS. 1 and 2,

FIG. 4 shows an axial section through a re-modified displacement sheath for a separation unit according to FIGS. 1 and 2,

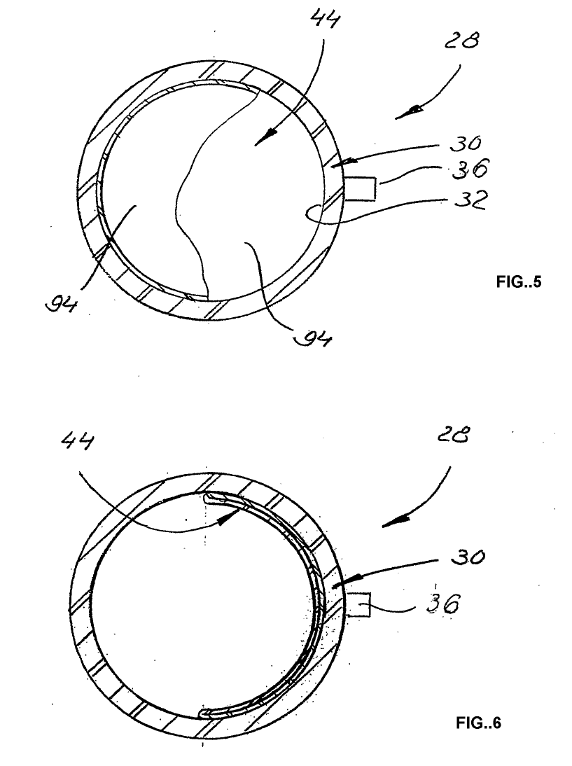

FIG. 5 shows a transverse section though a re-modified separation unit shown in the closed position,

FIG. 6 shows a similar section to FIG. 5, but in which the separation unit is reproduced in a conveying position,

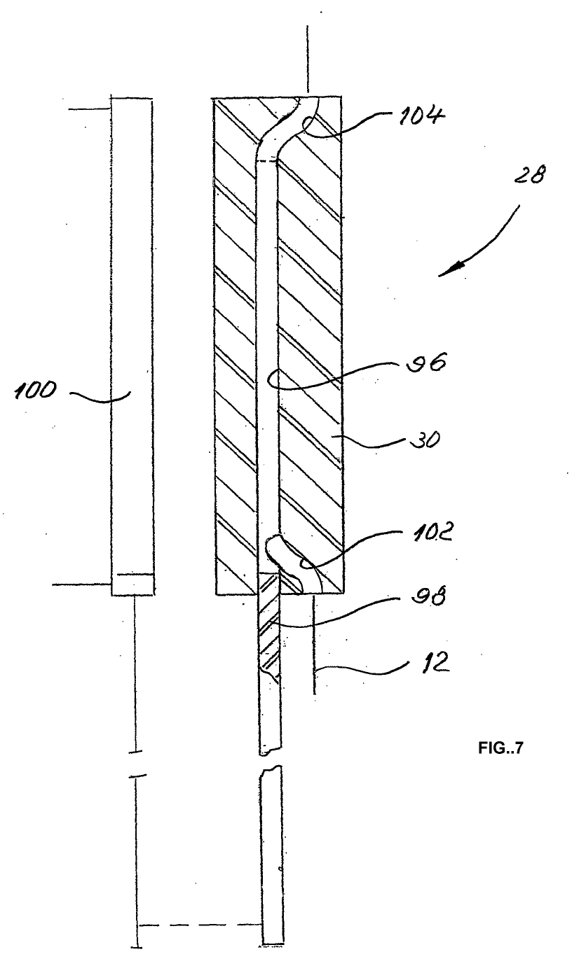

FIG. 7 shows an axial section through a further modified separation unit,

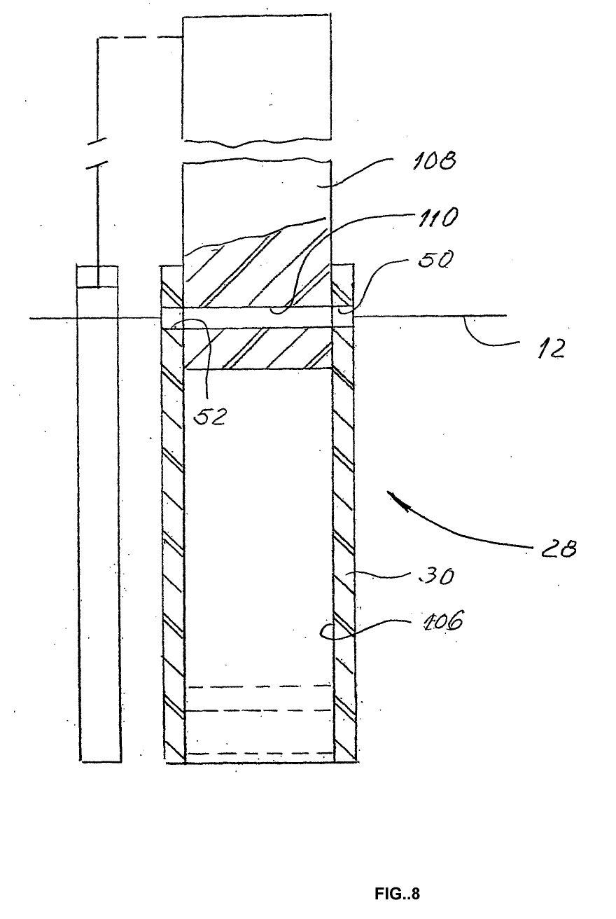

FIG. 8 shows an axial section through a further modified separation unit,

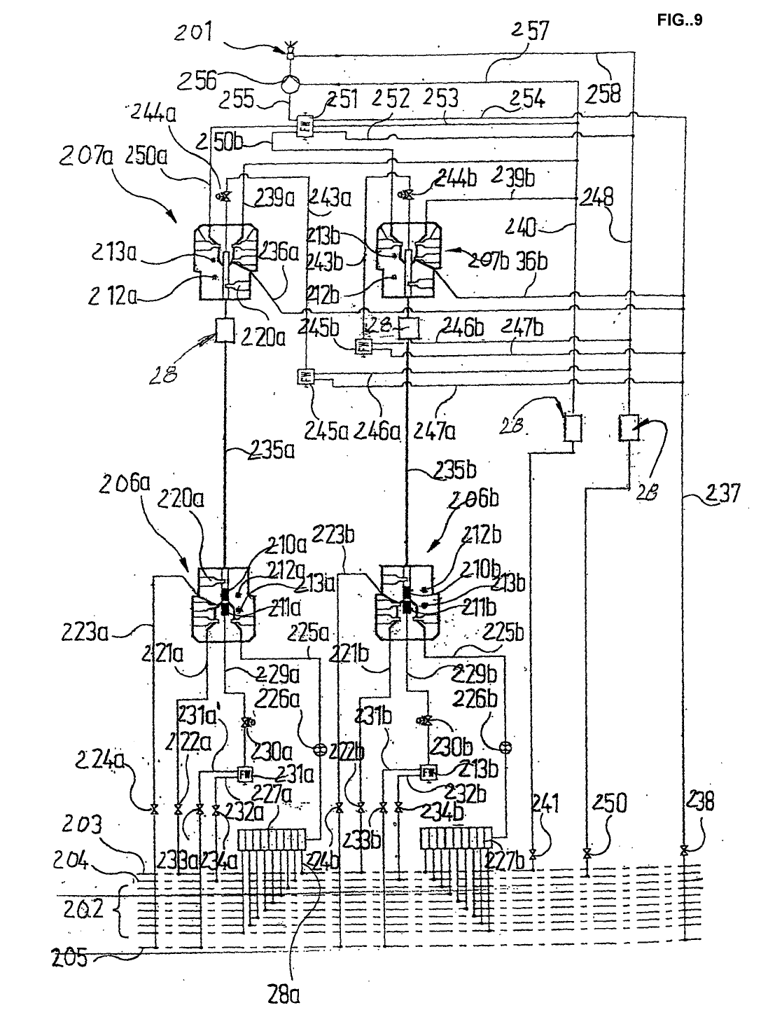

FIG. 9 shows a schematic view of an electrostatic multicolour spray plant in which separation units are inserted, as they are shown in FIGS. 1 to 8, and

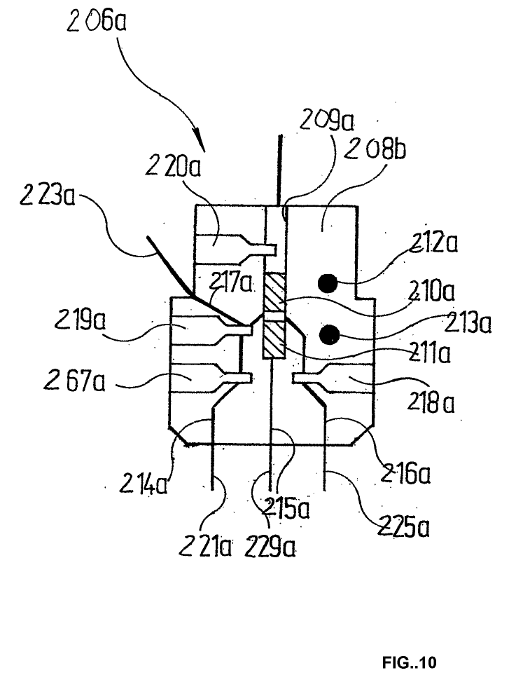

FIG. 10 shows an axial section through a pig unit of the spray plant shown in FIG. 9 on an enlarged scale.

In FIG. 1 reference character 10 designates a spraygun which is connected by a pipe 12 to the output of a paint pump 14. The paint pump sucks in paint from a storage tank 16 which contains a volume 18 of paint of a predefined colour.

The electrostatic spray method is used to improve a uniform application of paint to the workpiece. In this connection a workpiece, schematically indicated at 20, is connected to earth via a line 22, while the spraygun 10 is connected by a line 24 to the output of a high-voltage generator 26.

To spray paints used by vehicles, metallic paints in particular have an electrical conductivity that is absolutely crucial when subject to a high electrical field strength. This applies all the more so to water-based paints.

A separation unit 28 is inserted into the pipe 12 to electrically insulate the spraygun 10 from plant components connected to frame potential. This ensures that under operating conditions the potential of the high-voltage generator 26 is blocked against earth and, more precisely, also with respect to the paint being conveyed (or other conveyed, electrically conductive liquids or free-flowing powder).

The separation unit 28 has a sheath-like housing 30 made from plastics material that is a good electrical insulator and at its ends is provided with flanges 32.

A cylindrical chamber 34 is formed inside the housing 30 and is connected by a lateral connecting piece 36 of the housing and by a 2/2 solenoid valve 38 to the conveying side of a compressor 40 that provides compressed air.

A perforated support body 42 is arranged inside the chamber 34 so as to be radially inwardly offset from the wall surface thereof and is axially supported on the end walls of the chamber 34.

The support body 42 is used to support a deformable displacement sheath 44 in the radially outwards direction in a conveying position of the separation unit 28. This tube is made from an elastomeric material that is a good electrical insulator and in the unloaded state has a cylindrical basic geometry. Radial mounting flanges 46 are formed on the ends of the displacement sheath 44. The flanges are received in corresponding annular indentations 48 which surround an inlet opening 50 or an outlet opening 52 of the housing 30 and are provided in the end faces of the housing 30. Two annular clamping plates 54 are secured to the end faces of the housing 30 by means of screws 56 that are only indicated schematically. These have central openings 58 which constitute a smooth continuation of the inlet opening 50 or outlet opening 52.

The axial dimensions of the indentations are, as is conventional with seals, such that they are slightly smaller than the axial dimensions of the mounting flange 46, so the flange is slightly compressed when the clamping plate 54 is screwed on.

The separation unit 28 therefore has end flanges which are formed by the screwed-together flange 32 and clamping plates 54. These end flanges are in turn connected to flanges 60 which are provided at the ends of the parts of the pipe 12 that face away from the separation unit 28 and are tightly connected to these ends.

If the connecting piece 36 is pressurised, the displacement sheath 44 passes from the conveying position indicated by broken lines in FIGS. 1 and 2 into a blocking position reproduced by solid lines. In this blocking position the innately sleeve-like displacement sheath is compressed to form two vertically stacked layers, in a manner similar to that known with pinch valves. However this squashing-together process takes place over most of the axial dimension of the displacement sheath 44. In the blocking position the sheath therefore has a central tubular section 62 which comprises two layers that are vertically stacked in a planar manner and are compressed so as to be flat, as well as a transition section 64 which in the axially outwards direction creates a constant transition from the compressed, flat geometry to the round geometry which is forced in the case of the fixing points of the displacement sheath 44 owing to clamping of the mounting flange 46.

With the folding-together process of the displacement sheath 44 to give a flat geometry, obtained as a result of pressurisation of the connecting piece 36, the corresponding volume of paint situated in the separation unit 28 is pushed out in the axial direction.

There is therefore an insulating path inside the separation unit 28 which is free from paint and which ensures that when a high voltage is applied to the spraygun 10 no current flows to the part of the pipe 12 that is connected to the metering pump 14.

To ensure that electrically conductive paint is actually interrupted over a sufficient path following pressurisation of the chamber 34, the electrical resistance of the separation unit 28 may be measured in the simple manner described below:

While the housing 30 and the displacement sheath 44 are made from materials that are good electrical insulators, the clamping plates 54 are made from electrically conductive material. They are therefore simultaneously electrodes which can be used to measure the resistance of the separation unit 28. For this purpose the clamping plates 54 are connected by lines 66, 68 to the two inputs of an ohmmeter 70 which is also constructed as a discriminator. This can operate conventionally, for example measure the current that flows between the two clamping plates 54 respectively in the case of impressed voltage. If this current is below a predefined threshold, i.e. if the resistance of the separation unit 28 is above a predefined resistance value, the ohmmeter 70 generates a release signal at its output.

In an AND gate 72 this release signal is combined with a control signal which is provided by a controller 74 for the spraygun 10.

In simplified terms, this operates as a function of a switch 76 which is closed respectively if the spraygun 10 is supposed to operate, for which purpose it has to be connected to a high voltage.

If the switch 76 is closed, the controller 74 controls the 2/2 solenoid valve into the conducting position and simultaneously gives its control signal to the AND gate 72. A signal is at first not received at the output to the AND gate since its second input contains a low-level signal. This is because initially there is still paint inside the separation unit 28 which is electrically conductive and would cause a short circuit in the spraygun to earth by way of the metering pump 14. Only if the pressure inside the chamber 34 has increased to the extent that the displacement sheath 44 has been squashed completely flat is this electrical current path interrupted. The ohmmeter realises this and accordingly provides the second input signal for the AND gate 72 at its output. The output signal thereof is passed via an amplifier 78 to a control terminal of the high-voltage generator 26. The spraygun 10 is thereby connected to a high potential.

When working with the spraygun paint is then drawn from a storage tank 80 which is constructed in the manner of a hydraulic spring and is connected to the pipe 12.

Alternatively, instead of the storage tank 80 a forcing pump 82 could be provided which draws-in from an intermediate container 84 into which the paint pump 14 is conveyed.

The ends of the displacement sheath 44 are fixed in the housing 30 in such a way that the displacement sheath 44, in its initial geometry, which is retained when the chamber 34 is relieved of pressure, is a smooth continuation of the inner faces of the openings 58 of the clamping plates 54.

For this purpose the inlet opening 50 and the outlet opening 52 have a radius which is greater than the radius of the openings 58 of the clamping plates 54 by exactly the wall thickness of the unpressurised displacement sheath 44. The inner face of the support body 42 is a smooth continuation of the inlet opening 50 or the outlet opening 52.

As may be seen in more detail from FIG. 2, the axially outer and radially inner edges of the inlet opening 50 and the outlet opening 52 are rounded, as shown at 88. The clamping rings 88 at their axially inwardly located inner edge have wedge-shaped moulded grooves 90 which on their axially inwardly pointing side have a contour that runs parallel to the round portion 88 at the spacing of the wall thickness of the displacement sheath 44. An almost jolt-free, continuous inner face of the separation unit 28 is thus obtained if the displacement sheath 44 is not pressurised. This allows a separation unit, as has been described above, to also be used in piggable systems.

In the case of the modified displacement sheath 44 shown in FIG. 3 two diametrically opposed, axially parallel grooves 92 are worked into the outer faces. Two axially parallel attenuations are thus obtained which predefine the edges of the displacement sheath 44 that is folded together when pressurised. The grooves 92 thus provide defined folding-together of the displacement sheath 44 in a predetermined plane.

In the further modified displacement sheath 44 which is reproduced in FIG. 4 the wall thickness of the sleeve-like tubular section increases from the bottom up in the drawings. With use according to FIG. 1 this means a wall increase from inlet to outlet of the separation unit 28.

This ensures that with increasing pressure in the chamber 34 the displacement sheath 44 is increasingly squashed together from inlet to outlet of the separation unit 28. This progressive squashing-together of the displacement sheath 44 ensures that the volume of paint inside the displacement sheath is forcibly pressed out of the interior of the displacement sheath 44 in the direction predefined by the thickness profile of the sheath wall. No paint inclusions can form in the displacement sheath.

In the case of the modified embodiment according to FIGS. 5 and 6 parts of the separation unit 28, which in function-equivalent form have already been described above with reference to FIGS. 1 and 2, are again provided with the same reference characters.

The displacement sheath 44 is accordingly securely closed at its ends by end walls 94. The inside of the displacement sheath 44 can again be controllably pressurised with compressed air. The displacement sheath 44 accordingly does not have any mounting flanges 46 however but instead is permanently connected, for example glued, by part of its outside circumference, which is adjacent to the connecting piece 26, to the wall of the chamber 34.

In a conveying position of the separation unit 28, which when the connecting piece 36 is relieved of pressure is achieved in that the pressure of the incoming paint folds the displacement sheath 44 together, the two circumferential halves of the displacement sheath 44 are vertically stacked one above the other, as shown in FIG. 6. If desired the changeover of the displacement sheath 44 from the blocking position to the conveying position can be accomplished or assisted by subjecting the connecting piece 36 to negative pressure.

In the case of the separation unit according to FIGS. 5 and 6 the chambers 34 can, in a modification, be formed with two different halves: one chamber half has a radial dimension which is greater than the radius of the other chamber half by twice the wall thickness of the displacement sheath 44. A substantially continuous, cylindrical inner face of the separation unit is again thus obtained in the conveying direction of the separation unit 28, so this is also very well suited to piggable systems.

In contrast, when the connecting piece 36 is pressurised the displacement sheath 44 that is closed at its ends is inflated and closes the passage through the chamber 34.

To purposefully displace the medium (paint in the embodiment considered here), which at the start of the closing processes is in the separation unit 28, in one direction from the chamber 34, in a further development of the invention the displacement sleeve 44 can be slightly conical, so the section of the displacement sheath with the larger diameter already abuts the chamber wall at lower pressures than the section of the displacement sheath 44 with the smaller diameter.

In the embodiment shown in FIGS. 5 and 6 the displacement sheath 44 need only be slightly elastically deformed. It is substantially folded onto itself.

In the above-described embodiments the displacement sheath 44 is deformed by pressurisation with compressed air. In a modification pressurisation may also take place by using a sufficiently insulating liquid, in particular an insulating oil, such as transformer oil.

The separation unit 28 shown in FIG. 7 again has a housing 30 that is made from a material that is a good electrical insulator and is held by two end plates 54 which are made from metal and are also used for producing the connections to the conductive parts of the pipe 12.

Formed inside the housing 30 is a channel 96 in which a displacement rod 98, which is made from a material that is a good electrical insulator, can be displaced so as to be tight. To move the displacement rod 98 between a blocking position, reproduced in the drawings by broken lines, and a conveying position, reproduced in the drawings by solid lines, a drive 100 is used which can be formed by a linear motor as a dual-acting cylinder.

The inlet opening 50 of the separation unit 28 is connected to the channel 96 by an S-shaped channel 102. The outlet opening 52 is connected to the channel 96 by an S-shaped channel 104 in the opposite direction, so the two connections of the separation unit 28 are coaxial. Where this is not important the outlet opening 52 may also be directly connected to the channel 96.

Broadly speaking the separation unit shown in FIG. 7 operates as follows:

In the conveying position paint conveyed by the metering pump 14 is conveyed through the separation unit 28 to the spraygun 10.

By appropriate control of the drive 100 the displacement rod 98 is moved in the channel 96 and pushes paint that is still present therein into the temporary storage facility 80.

The fit between the displacement rod 98 and the channel 96 is so good that a paint film potentially remaining between the mutually opposing surfaces of the displacement rod and channel is so thin that overall very high resistance is obtained. As a result of the fact that the effective axial extension of the displacement rod 98 is increased, the resistance of a paint film potentially remaining between the cooperating outside circumferences of displacement rod and channel may be increased further if there is a desire or a possibility for the fit between displacement rod and channel to be chosen so as not to be even tighter.

As in the embodiment according to FIG. 1 it may be monitored by way of a resistance measurement whether the electrical insulation ensured by the separation unit 28 is adequate and the measurement result may also be used to automatically apply the high voltage to a spraygun or another load connected to a high-voltage potential.

There is also a housing 30 which is made from a material that is a good electrical insulator and is held by metal end plates 54 in the case of the separation unit according to FIG. 8. Formed in the housing 30 is a chamber 106 in which a slide 108 is arranged which is also made from a material that is a good electrical insulator. Formed in the slide 108 is a hole 110 which can be moved into a position aligned with the inlet opening 50 and the outlet opening 52 in which the separation unit predefines a piggable, smoothly continuous through-opening. From this conveying position the slide 108 can be moved by a drive 100 in the direction transverse to the axis of the hole 110, as shown schematically in FIG. 8.

If the slide 108 is moved from the conveying position, shown by solid lines in FIG. 8, into an insulating position, shown in broken lines in FIG. 8, the paint column in the hole 110 is also electrically moved out of the pipe 12. A small flow could still flow only by way of a thin paint film that remains on the cooperating surfaces of the slide 108 and housing 30. The amount thereof can on the one hand be reduced by improving the fit between slide and housing and on the other hand be prevented by increasing the stroke of the slide movement.

FIG. 9 shows the fluidic part of a multicolour spray plant, wherein loading of an electrostatic spraygun 201 with high voltage is omitted for the sake of clarity.

The paint supply system shown in FIG. 9 is used to optionally supply a sprayer 201, illustrated at the top edge of the figure and working with interior charging, with a colour different to the paint and which circulates in the colour supply pipes 202 illustrated at the lower edge of FIG. 9. In the illustrated system there are seven such colour supply pipes 202, so seven paint colours may therefore be processed. A solvent supply pipe 203, a waste disposal pipe 204 and a compressed air pipe 205 also run parallel to the paint supply pipes 202.

Paint is supplied from the colour supply pipes 202 to the sprayer 201 via two parallel system branches. The reference characters of the components which belong to the left-hand system branch in FIG. 9 are provided with the addition “a”; the reference characters of those components which belong to the system branch located to the right in FIG. 9 are provided with the addition “b”. Since both branches have identical constructions only the system branch located to the left in FIG. 9 will be described in more detail hereinafter.

As the most important component this system branch comprises a first pig station 206a adjacent to the colour supply pipes 202 and a second pig station 207a adjacent to the sprayer 201. The construction of all pig stations 206a, 206b, 207a and 207b in the paint supply system is identical, so it is sufficient to describe in more detail the construction of pig station 206a with reference to FIG. 10.

The pig station 206a comprises a housing 208a in which a movement channel 209a is constructed for two pigs 210a, 211a arranged in series. The two pigs 210a and 211a are shown in FIGS. 9 and 10 inside the pig station 206a in their respective parking positions.

A total of four channels 214a, 215a, 216a and 217a lead through the housing 208a to the movement channel 209a, via which channels, in a manner yet to be described, different media may be introduced at different points of the movement channel 209a. The middle channels 215a in FIG. 10 leads to the end of the movement channel 209a, so the medium supplied here can load the end face of the pig 211a that is at the bottom in FIGS. 9 and 10. The other channels 214a, 215a, 216a, 217a on the other hand end, from the opposing sides, in the movement channel 209a at a position which is between the two pigs 210a and 211a, so from this point on the space located between these two pigs 210a and 211a can be reached.

A respective shutoff valve 267a, 218a, 219a is located in each of these three channels 214a, 216a, 217a.

A stopper 220a, actuated by compressed air, can be inserted into the movement channel 209a of the pigs 210a, 211a. Exiting of the pigs 210a, 211a from the pig station 206a or entry of these pigs 210a, 211a into the pig station 206a is possible only when the stopper 220a is withdrawn.

As FIG. 9 shows the lower, left-hand channel 214a of the pig station 206a is connected by a pipe 221a, in which a shutoff valve 222a is situated, to the solvent supply pipe 203. The channel 217 located top left in FIG. 9 is connected by a pipe 223a, in which a shutoff valve 224a is situated, to the compressed air pipe 205. The channel 216a located bottom right in FIG. 9 is connected by a pipe 225a, in which a flow measuring unit 226a is situated, to a colour-change unit 227a.

The colour-change unit 227a is in turn connected by a total of nine branch pipes 228a to the colour-supply pipes 202 and to the solvent supply pipe 203 and the waste disposal pipe 204. The colour-change unit 227a is capable of optionally producing a connection between the pipe 225a and one of the pipes 202, 203, 204.

Finally, the channel 215a running in the central, lower region of the housing 208a of pig station 206a in the drawings is connected by a pipe 229a, in which a controllable throttling valve 230a is situated, to a reversing valve 231a. The reversing valve 231a is capable of connecting the pipe 229a optionally to a first branch pipe 232a or a second branch pipe 233a and of breaking both connections. The left-hand branch pipe 231 in the drawings leads via a shutoff valve 233a to the compressed air supply pipe 205, while the right-hand branch pipe 232 in the drawings leads via a shutoff valve 234a to the waste disposal pipe 204.

The mouth of the movement channel 209a of pig station 206a is connected by a pig line 235a, shown only schematically in the drawings, to the mouth point of the movement channel 209a of the pig station 207a arranged in the opposite direction and adjacent to the sprayer 201. The pig pipe 235a can be a flexible tube, of which the internal diameter is adapted in a known manner to the external diameter of the pigs 210a, 211a such that during their movement through the pig pipe 235a the circumferential surfaces of the pigs 210a, 211a are connected in a fluid-tight manner to the inner circumferential surface the pipe.

The various channels 229a, 214a, 215a, 216a and 217a of the spraying pig station 207a are incorporated into the system as follows:

The channel 217a is connected by a pipe 236a to a compressed air-collecting pipe 237 which in turn is connected by a shutoff valve 238 to the compressed air pipe 205.

The channel 214a of the pig station 207a is connected by a pipe 239a to a solvent-collecting supply pipe 240a which is connected by a shutoff valve 241 to the solvent supply pipe 203. The solvent-collecting supply pipe 240 is interrupted at one point by a separation unit 28, as has been described above.

The channel 215a of the pig station 207a that is close to the sprayer is in turn connected by a pipe 243a, in which a controllable throttling valve 244a is situated, to a reversing valve 245a. The reversing valve 245a is capable of optionally connecting pipe 243a to one of the two pipes 246a or 247a or off shutting it off. The upper pipe 246a in the drawings leads to a waste-disposal collecting pipe 248 which in turn is connected by a separation unit 28 and a shutoff valve 250 to the waste disposal pipe 204.

Finally, the channel 216a of the pig station 207a close to the sprayer is connected by a pipe 250a to a further reversing valve 251, to which the pipe 250b, corresponding to the pipe 250a, of the right-hand system branch in the drawings leads. The two system branches are hereby funneled at the reversing valve 251. The reversing valve 251 is capable of optionally connecting each of the pipes 250a, 250b to one of four pipes 252, 253, 254, 255 or of shutting them off.

The lowest pipe 252 in the drawings leads to the waste disposal collecting pipe 248, the pipe 253 located thereabove to the solvent-collecting supply pipe 240, the pipe 254 again located thereabove to the compressed air-collecting pipe 237 and the pipe 255 extending substantially upwards from the reversing valve 251 to a metering pump 256, of which the outlet is in turn connected to the sprayer 201. The metering pump 256 may also be supplied with solvent from the solvent-collecting supply pipe 40 via a pipe 257. Finally, the sprayer 201 is connected by a further pipe 258 to the waste-disposal collecting pipe 248.

In the following description of the mode of operation of the paint supply system, the right-hand system branch in the drawings, which contains the components denoted by b, will initially not be considered. The manner in which this system branch intervenes in the overall function will be subsequently described.

First of all the situation shown in the drawings, in which the pigs 210a, 211a are located in the pig station 206a adjacent to the paint supply pipes 202, is taken as a starting point. The presence of the pigs at this location is verified by the detectors 212a, 213a. The stopper 220a has entered the movement path of the pigs 210a, 211a, so that they cannot leave the pig station 206a. It is also assumed that all components have been cleaned, using a method that is not yet of interest here, of paint residues originating from an earlier painting operation. For a new painting operation a specific volume of the paint conveyed to the colour-supply pipes 202 is now to be supplied to the sprayer 201. The procedure is as follows for this purpose:

Firstly a connection is established between the desired colour supply pipe 202 and the pipe 225a leading to the channel 216a of the pig station 206a by opening the corresponding shutoff valve in the colour-change unit 227a. The stopper 20a is withdrawn, so there is no longer anything to prevent the upper pig 210a from exiting the pig station 6a. By opening the valve 218a in the pig station 206a paint can now enter the gap between the two pigs 210a and 211a and push the upper pig 210a in the drawings out of the pig station 206a.

In the process the pig 210a displaces the air, which is in front of it in the direction of movement in the pig pipe 235a. The air is supplied via the movement channel 209a of the pig station 207a, which is close to the sprayer, the channel 215a thereof and the pipe 243a and, with an appropriate setting of the reversing valve 245a, via the pipe 246a and the waste disposal pipe 248, when the shutoff valve 250 is open, to the waste disposal pipe 204. In the process the throttling valve 244a, which in flow terms is situated downstream of the pig station 207a that is close to the sprayer, is adjusted such that the desired rate of motion of the pig 210a in the pig pipe 235a results.

The volume of paint which is passed into the gap between the moving pig 210a and the pig 211a still in its parking station in pig station 206a is monitored by the volumeter 226a. Once the desired volume is attained both the corresponding shutoff valve in the colour-change unit 227a and the shutoff valve 218a in the pig station 206a are closed. The second pig 211a at the lower end face in the drawings is now connected by the pipe 229a and the correspondingly set reversing valve 231a to the compressed air pipe 205 once the shutoff valve 233a has been opened. The compressed air now also pushes the pig 211a out of pig station 206a and—by way of the paint enclosed between the two pigs 210a and 211a—pushes forward the pig 210a which exited the pig station 206a first and which up until this instant has been forced forward by the paint.

A type of “packet” is now formed from the two pigs 210a and 211a and the volume of paint enclosed therebetween, which is moved forward in the pig pipe 235a by the compressed air supplied via the pipe 229a. The throttling valve 230a in pipe 229a is fully opened in the process.

After passing through the pig line 235a the precursory pig 210a firstly enters the pig station 207a that is close to the sprayer, wherein the stopper 220a thereof must of course be withdrawn. The detector 213a of pig station 207a detects when the end and parking positions are attained by the pig 210a. The connection to the waste disposal pipe 248 is now interrupted in the reversing valve 245a. At the same time the pipe 250a is connected by appropriate reversal of the reversing valve 251 to the metering pump 256 via the pipe 255. If the second pig 211a, pushing the volume of paint before it, now approaches the pig 210a that has come to a stop in its parking position in the pig station 207a, the volume of paint is displaced via the pipes 250a and 255 toward the metering pump 256. The workpiece, for example a car body, can now be painted by appropriate actuation of the sprayer 201. The respectively required volume of paint is adjusted by the metering pump 256.

Once the painting operation is complete the high voltage is removed from the sprayer 201. The sprayer 201, the metering pump 256 and the pipe 255 between metering pump 56 and reversing valve 251, with appropriate setting of the reversing valve 251, is flushed via the pipes 253 and 257 and via the pipe 258 when shutoff valves 241 and 250 are open.

The residual paint that still remains between the pigs 211a and 210a in pig station 207a is disposed of by setting the reversing valve 251 such that pipe 250a is now connected to pipe 252 and therefore to waste disposal pipe 204.

If the detector 212a of the pig station 207a that is close to the sprayer determines that the second pig 211a has also attained its parking position within the pig station 207a, the stopper 220a of pig station 207a is drawn out, whereby the two pigs 210a, 211a are secured in the pig station 207a that is close to the sprayer.

The paint in pipe 250a, which connects the pig station 207a to the reversing valve 251, is then disposed of in the following way: the valves 267a and 218a of pig station 207a are opened and the reversing valve 251 actuated in such a way that a connection between the pipe 250a and the waste-disposal collecting pipe 248 is established. Solvent may thus flow through the space located between the two pigs 210a, 211a and the pipe 250a and clean the corresponding channels. By alternate opening of valves 219a and 267a flow-through can alternate in pulsed form with compressed air and solvent. To conclude this cleaning process any solvent that may be found between the pig station 207a and the reversing valve 251 is pushed out by compressed air.

Return conveying of the two pigs 10a, 211a from the pig station 207a, which is close to the sprayer, to the pig station 206a, which is adjacent to the colour-supply pipes 202, can now be started. Cleaning of the connecting path between the two pig stations 207a, 206a, in particular of pig line 235, takes place in the process. A “packet” is again produced which is formed from the two pigs 210a and 211a and a volume of liquid enclosed by them. However this liquid is now a cleaning solvent. In detail the processes are as follows:

Firstly the stopper 220a of pig station 207a is withdrawn, so the path for the pigs 210a, 211a is free. The throttling valve 230a, which is located downstream of pig station 206a in the flow direction, is now adjusted such that a certain resistance results for the air that is to be displaced and which is situated in the pig pipe 235a, whereby the rate of motion of the pigs 210a, 211a and the volume of solvent enclosed therebetween is determined.

First of all, by opening the valve 267a of pig station 207a, with shutoff valve 241 open, solvent is brought into the gap between the two pigs 210a and 211a via the solvent-collecting supply pipe 240 and the pipe 239a.

Then, in this case, precursory pig 211a is consequently pressed out of the pig station 207a.

Provided in the vicinity of the pig line 235a at a certain distance from pig station 207a is a further detector 260a which responds to the passing-by of the two pigs 210a, 211a. If the detector 260a establishes that the precursory pig 211a has passed the corresponding point in pig pipe 235a, the valve 267a is closed and further supply of solvent into the gap between the two pigs 210a, 210b is interrupted.

With the throttling valve 244a substantially open compressed air is now passed by way of the reversing valve 245a via the compressed air-collecting pipe 237 and the pipes 247a and 243a to the, in the drawings, upper, end face of the pig 210a that is still in pig station 207a. The compressed air now pushes the entire “packet” consisting of the two pigs 210a, 210b and the enclosed volume of solvent through pig line 235a. If the following-on pig 210a passes the detector 260a there is an adequate insulation path between the “packet” and the pig station 207a, so the high voltage can be applied to the sprayer 201 again.

Finally the precursory pig 211a in this cleaning process finally enters the pig station 206a that is adjacent to the supply pipes 202. If the detector 213a of pig station 206a detects that the pig 211a has attained its parking position again, shown in the drawings, the connection between pipe 229a and the waste disposal pipe 204 is interrupted in the reversing valve. Instead the valve 218a of the pig station 206a and the corresponding valve inside the colour-change unit 227a is opened such that the volume of solvent enclosed between the two pigs 210a, 211a can be pressed via the pipe 225a and the colour-change unit 227a into the waste disposal pipe 204. The connecting pipe 225a, and the volume measuring unit 226a located therein, is simultaneously cleaned of paint.

If the detector 212a of pig station 206a establishes that the following-on pig 210a has also entered its parking position in pig station 206a, the stopper 220a of pig station 206a is inserted, so the two pigs 210a, 211a are secured in pig station 206a. The flushing process may be continued by opening the shutoff valve 222a in the pipe 21a and the valve 267a in pig station 206a. By alternately opening the valves 267a and 219a of pig station 206a cleaning can again be carried out in pulsed manner, alternately with compressed air and with solvent. The final flushing process should again take place with compressed air.

The valves 218a of pig station 206a and the shutoff valve, leading to the waste disposal pipe 204, of the colour-change unit 227a are now closed. The left system branch in the drawings has now been completely cleaned and is ready for a new painting operation using the same or a different colour.

In principle the paint supply system can be operated in the above-described manner using a single system branch. Owing to return conveying of the two pigs 210a, 211a from the pig station 207a, which is close to the sprayer, to the pig station 206a adjacent to the paint supply pipes 202 and the cleaning process associated therewith, undesirable pauses occur in the painting operation, however. For this reason in the embodiment illustrated in the drawings the second system branch is provided which, as already mentioned, is constructed so as to be identical to the first system branch. The two system branches are moved in the manner of a push-pull to the extent that one branch is always in the mode in which paint is conveyed in the direction of the sprayer 201 while the other branch is in cleaning mode in which the corresponding pig pipe 235a or 235b and the other components of this system branch are freed from the paint residues.

If no colour change is to take place between two painting operations the above described procedures can proceed in an analogous manner although cleaning processes may be omitted.

A respective separation unit 28, as has been described above with reference to FIGS. 1 to 8, is inserted into the pipes 235a, 235b, 237, 240 and 248, which extend from a gun-side component of the plant that is connected to high voltage to a supply-side component of the plant. This insertion preferably takes place in the vicinity of the plant components which are to be kept at a high voltage at substantially equivalent points in the pipe to keep the plant components connected to a high voltage small and to simultaneously ensure that adjacent plant components are as far as possible at the same potential.

The separation units 28 can also assume the function of servo valves if pipes are cleaned using solvent and/or compressed air during cleaning of the plant.

From the above description of the separation units it may be seen that in the conveying position they provide a free passage for the conveyed medium. They also have only very small clearance volumes. There is no notable loss of pressure in the conveying position. They may also be produced so as to be very tight and leakage-free using simple means. They may also be handled very easily.

Chloroprene polymers such as neoprene, EDPM (ethylene/propylene terpolymers), fluoroelastomers, such as Viton, PTFE (polytetrafluoroethylene) and chlorobutyl polymers in particular are suitable as materials for insulating elastomeric displacement bodies.

In addition to deformability and good electrical insulation these materials also have the advantage that they are usually very wear-resistant, so the separation units have a long service life even when conveying abrasive media such as paints.

Polytetrafluoroethylene, polyamide, polyethylene, polyoxymethylene, polyvinylidene fluoride, polypropylene, in particular PP ST1000, are especially suitable as material for the insulating housing of the separation units.

In the case of the above-described embodiments which comprise deformable displacement bodies, these have been connected to the housing of the separation unit so as to be tight by using clamping pieces. In a modification or in addition end sections of the displacement body may also be directly vulcanised onto a housing section of the housing of the separation unit.

1. An electrical separation unit for a liquid supply pipe, comprising: a housing made from an electrically insulating material and in which a liquid channel communicating with an inlet and an outlet is formed, and by means for displacing liquid from the liquid channel.

2. The separation unit of claim 1, wherein the displacing means comprise a pressurisable, deformable displacement body.

3. The separation unit of claim 2, wherein the displacement body is hollow and substantially cylindrical or shaped like a truncated cone.

4. The separation unit of claim 3, wherein the displacement body is provided with mounting flanges at its ends which are fixed between an end face of the housing and a clamping plate, respectively.

5. The separation unit of claim 1, further comprising a support body which supports the displacement body in the unpressurised state and is permeable to a working liquid with which the displacement body can be pressurised.

6. The separation unit of claim 5, wherein the radius of the support body is greater by the wall thickness of the displacement body than the radius of the inlet and outlet of the housing.

7. The separation unit of claim 6, wherein the clamping plates have a moulded groove which in profile is adapted to a rounded portion of the opposing end of the housing.

8. The separation unit of claim 2, wherein the displacement body comprises an attenuation line.

9. The separation unit of claim 2, wherein the displacement body is elongated and increases in diameter and/or wall thickness from its one end to its other end.

10. The separation unit of claim 2, wherein the displacement body is closed on all sides and with part of its circumferential face is permanently connected to the wall of the liquid channel of the housing.

11. The separation unit of claim 1, wherein the displacement body is constructed as a rod made from electrically insulating material, which is displaceable in a channel, which forms part of the liquid channel of the housing, so as to be tight.

12. The separation unit of claim 11, wherein the channel is connected by S-shaped channel sections to inlet and outlet of the housing.

13. The separation unit according to claim 1, the displacement element is constructed as a slide made from electrically insulating material and which comprises a hole which can move between a conveying position communicating with inlet and outlet of the housing and a separating position that is physically remote therefrom.

14. The separation unit of claim 1, wherein the housing is provided with two spaced-apart electrical contacts that are preferably each adjacent to one of the liquid connection openings.

15. The separation unit of according to claim 14, further comprising an ohmmeter connected to the contacts.

16. The separation unit of claim 15, wherein the ohmmeter is constructed as a threshold switch and its output signal is conveyed to a control terminal of a high-voltage generator.

17. The separation Separation unit of claim 1, further comprising: according to any one of claims 1 to 16, characterised by a liquid storage device which is connected to the supply pipe downstream of the outlet to the housing.
